(19) United States
(12) Patent Application Publication
(10) Pub. No.: US 2026/0246892 A1
(43) Pub. Date: Aug. 20, 2026

(54) IDENTIFICATION OF A PRINTING SUBSTANCE LOAD FOR A PRINT JOB

(71) Applicant: Hewlett-Packard Development Company, L.P., Spring, TX (US)

(72) Inventors: Li Qian, Sant Cugat del Valles (ES); Anastasiia Gudzenchuk, Sant Cugat del Valles (ES)

(21) Appl. No.: 17/766,784

(22) PCT Filed: Feb. 3, 2020
(86) PCT No.: PCT/US2020/016398

§ 371 Date: Apr. 6, 2022

(51) Int. Cl. H04N 1/60; G06F 3/12

(52) U.S. Cl. CPC H04N 1/6061; G06F 3/1208; G06F 3/1214; G06F 3/1256; H04N 1/6097

(57) ABSTRACT

Example implementations relate to a method and computer program for identifying a printing substance load for printing a job and a printer for implementing the method. The printing substance load for printing a job is identified by receiving calibration data indicating an achievable range of colors that are physically reproducible on a given printing surface for each of a plurality of different printing substance loads. A target range of colors to be printed is received by the printer for at least the print job. For each of the plurality of different printing substance loads, the achievable range of colors is compared with the target range of colors and an appropriate printing substance load for the print job is selected based on the comparison.

### BACKGROUND

Printing devices that deposit printing substance onto a print surface to reproduce an item to be printed may have control settings to vary, for example, a print quality and a printing speed. The print quality may be influenced by factors including a quality and type of print target (e.g. paper or textile), a printing substance load per deposition region of the printer, a type and quality of printing substance(s) and specifications of the printer such as dots per inch (DPI). Evaluation of an accuracy of color reproduction in the printout relative to the item to be printed (for example, a source image or 3D object) is one measure of print quality. In addition to achieving a good print quality, it is desirable to keep a cost per copy low and print production speed high. The quantity of printing substance used to print reproduce an item to printed is a factor in both print quality and print efficiency.

Color printing devices, such as inkjet printers may reproduce the source image, which could be in an Red Green Blue (RGB) color space of a computer monitor using a plurality of printing substance cartridges having respective different colors of a printer color space. One example of a printer color space is a Cyan, Magenta, Yellow and Black (CMYK) color space. A conversion between the source file color space and the printer color space may be determined via a process of colorimetric device characterization known as profiling to generate an ICC (International Color Consortium) profile to include linearization curves. An accurate CMYK ICC printer profile is one factor in faithful color reproduction.

The color printing device may have two or more different print modes. In the example of an inkjet printer, different print modes may comprise different number of passes of a printhead across the same region of a printing surface to generate the printed image.

Different source images or other items to be printed may vary in characteristics such as color range and color coverage. Furthermore, different printing targets may result in different print qualities for a given printing substance load per color deposition region. The color deposition region may be 2D region in the case of 2D printing area on a working surface or a 3D volume in the case of 3D printing. The color deposition region may form a whole or a part of the 2D region or 3D volume. For example, in the case of 2D printing, lighter grade paper may be less absorbent so may be less resilient to larger printing liquid amounts without smudging or other distortions.

If a larger printing substance load is to be delivered to the color deposition region during printing, then it may be appropriate to reduce a number of traversals of the printhead over a working area per in a predetermined time to achieve this. The working area may be a 3-dimensional region in the example of 3D printing or a working surface in the example of 3D printing. A reduced number of traversals may be appropriate if, for example, the printing substance ejection-speed from the printhead nozzle(s) is not sufficiently high to satisfy the requested printing substance load. A reduction in the number of printhead scanning traversals of the working area in a predetermined time interval may reduce printing throughput but improve color reproduction accuracy whereas an increase in printhead traversals may increase printing throughput but reduce color reproduction accuracy. Thus there is a balance to be struck between: (i) achieving a good printing throughput and low cost per copy; and (ii) achieving an acceptably high quality of the printout that accurately reproduces a color range in the item to be printed. An appropriately selected print fluid load and perhaps can improve print production efficiency and yet result in good print quality.

### BRIEF INTRODUCTION OF THE DRAWINGS

Example implementations are described below with reference to the accompanying drawings, in which:

FIG. 1 schematically illustrates a printing environment according to some examples;

FIG. 2 schematically illustrates color gamuts provided by each of a plurality of different printing substance loads in reproduction of a given item to be printed;

FIG. 3 is a flowchart schematically illustrating a method of identifying a printing substance load based on a comparison of a range of target colors in a item to be printed with a range of achievable colors reproducible in a printout of the item to be printed with a respective printing substance load;

FIG. 4 is a flowchart schematically illustrating a method of identification of a printing substance load based on a comparison of an overlap between a target color gamut of an item to be printed and achievable color gamuts for a range of printing substance loads;

FIG. 5 is a flowchart schematically illustrating a method of identification of a printing substance load based on a comparison of a target range of colors and an achievable range of colors for a printing substance load for the item to be printed and in addition taking account of a color fill of a fill area of a print job; and

FIG. 6 schematically illustrates a printer comprising machine-readable storage and machine executable instructions according to some examples.

### DETAILED DESCRIPTION

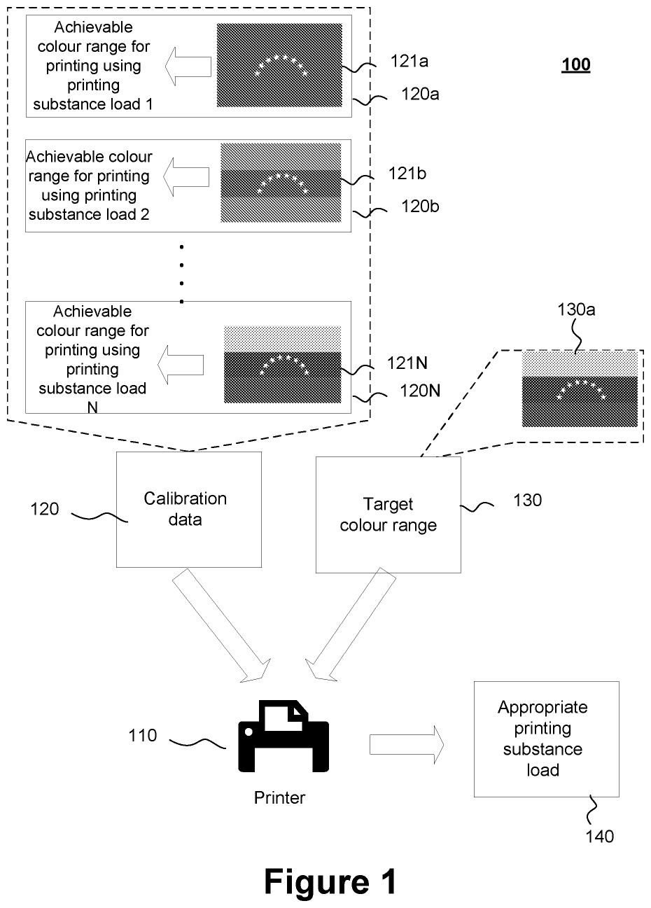

FIG. 1 schematically illustrates a printer 110 in a printing environment 100, where an appropriate printing substance load 140 for processing a print job is identified algorithmically. In this non-limiting example, the printer 110 is an inkjet printer. However, the present technique may be applied to any type of printer including inkjet printers, laser printers, 3D printers and additive manufacturing systems. A printing substance load may be, for example, a maximum volume of printing substance deposited in a given area on a printing surface. This printing substance load may be measured, for example, as a number of dots per pixel in 2D printing examples. The printing substance load may be defined in one non-limiting example as a 600 dpi by 600 dpi cell. The printing substance load may provide an indication of an average coverage of printing substance per unit area or volume. In the example of 3D printing, the printing substance load may be, for example, the volume of color-carrying printing substance deposited on an uppermost surface of a most recently deposited layer of build material on the print target. Examples of one or more build materials can comprise at least one of a polymer, or other plastic, a metal powder, a ceramic powder or other powder-like material, or lengths of such build material.

The inkjet printer 110 may have a printhead comprising a plurality of nozzles to deliver a printing substance to a printing medium. However, the printer could alternatively be another type of printer having a configurable printing substance load. The inkjet printer 110 comprises one or more printheads having a plurality (e.g. hundreds) of nozzles to deliver printing substance to the printing surface. The nozzles of the printhead may be connected to a printing substance supply comprising, for example, a plurality of print cartridges having respective CMYK cartridges. The printhead may be mounted on a print carriage that traverses over the printing surface of a print medium and printing-fluid ejection mechanisms associated with the nozzles are controlled to eject drops of printing substance in print deposition regions at appropriate times under control of a print processor. The printer 110 may have a Raster Image Processor (RIP) to convert the source image in RGB format to a bitmap that can be interpreted by the printer 110. In one sweep across the printing surface, the printhead may create one stripe by depositing the printing substance on the printing surface and this stripe of print is known as a “swath”. There may be a predetermined maximum amount of printing substance that can be deposited by the printhead in one swath.

The printing medium may be, for example, a paper medium or a textile medium. The printing medium may be characterized by one of a number of different surface types such as a matt finish or a gloss finish. In some examples the printing medium may be a transfer medium such as a transfer paper from which a printed image may be subsequently transferred to a textile, via sublimation, for example. The printing substance used to print onto transfer paper in this way may be dye sublimation ink.

Alternatively, the printer may be a color laser printer for depositing different hues of toner particles onto a photoreceptor drum (or an alternative type of transfer member) onto which a laser has drawn a representation of a source image. Each hue of toner particle may be deposited on the photoreceptor drum using a respective developer roller, where it may cling to oppositely electrically charged regions of the photoreceptor drum to reproduce a version of the source image on the drum. A thin but uniform layer of toner is delivered to the photoreceptor drum by mixing toner particles in a hopper and delivering them via a developer roller (or alternative transfer mechanism such as a belt) and a doctor blade. The image from the photoreceptor drum is then transferred onto paper or other final substrate such that the different colored toner particles rest lightly on the paper's surface. The paper is then passed through a fuser unit to fuse the toner particles into the paper by application of heat to produce the laser printout. Thus color deposition of toner (printing substance) by a laser printer may be performed by one or more rollers dispensing toner particles rather than printhead nozzles. Furthermore, the reproduced image of printing substance may be first created on the photoreceptor drum to include all hues (e.g. CMYK) of toner particles and subsequently transferred to the final print substrate. In example laser printer implementations the printing substance loading may be varied by varying at least one of the electrostatic charge on the printer components and the amount of color toner released onto the developer roller per unit area.

The present technique is applicable to any printing appliance. For different printing technologies, the way in which the color saturation is adjusted may differ.

To determine the appropriate printing substance load 140 for a given print job to print a given source image, a set of calibration data 120 is utilised and compared with a target color range 130 determined from a source image 130a. The comparison may be performed in a device-independent color space to promote an accurate comparison.

Although in this example the target color range 130 is determined based on a single source image for a print job, in alternative examples the target color range may be applied to a plurality of print jobs such as a list of representative historical print jobs. In some examples the user may manually select one or more representative historical print jobs. Similarly, the target color range may be determined with respect to a part of a print job such as a portion of a target file to be printed. For all of the example arrangements described herein, the identification of the appropriate printing substance load may be based on a target range of colors for at least a portion of a forthcoming print job or alternatively based on a target color range compiled from at least a subset of color date derived from a repository of print job data comprising previously performed print jobs.

A print job is queueable print system object representing a “target” file to be printed. The target file may comprise a source image to be reproduced but this target file may be in a computer-readable format such as a pdf file or a jpg file, which may undergo conversion to a form that the printer 110 can use. The source image may comprise, for example, a picture, a pattern, text or a combination thereof in an RGB color space. The print job may be spooled by a print processing application to render the source image in the target file to generate a spool file that may be read by a print processing application to control the printer 110 to generate a print output corresponding to the source image.

The spool file transforms the source image into a set of instructions for the printer 110 to follow to place “dots” of printing substance on different areas of the printing surface of a print medium, which determines where a printhead of the inkjet printer 110 places each dot of printing substance on the printing surface and also determines which color to print at specific dot locations. A process called halftoning may be used to create a binary representation of a continuous tone image during creation of the spool file. In the halftoning process a higher color density may be achieved by printing dots closer together on the printing surface whereas a lower color density may be achieved by printer more widely spaced dots.

The source image may have one or more “fill regions” of continuous or block color and may have other regions with more sparse or perhaps absent color. A given fill region may have a predetermined minimum area that may be set as appropriate by a user or otherwise. Print reproduction of fill regions of the source image may use a relatively large amount of printing substance per color deposition region in comparison to source image regions having more sparse color characteristics.

The CMYK color space of the printer 110 differs from a color space, for example a Red, Green Blue (RGB) color space used by computer screens, which is light based and thus color reproduction between a computer-based source image and the printer 110 is carefully calibrated. In the CMYK color space the CMY and K pigment colors are deposited on the print target to get light of the respective color emitted. By adding two of C, M and Y colors on a white printing surface, red, green or blue can be obtained. The ink dots of different colors may be laid on top of one another to achieve different colors or different colors of dots can be place in close proximity to generate a target color. Adding a third color gives a brown hue but adding a fourth K pigment enables a mix to obtain most colors. Each color may be represented, for example, as a number between 0 and 100 in the L*a*b* color space. All colors in HSL (Hue Saturation Lightness) color space with maximum saturation may be expressed as a hue of pure color. A tint may be created by adding white to a hue, a tone may be created by adding grey to a hue and a shade may be created by adding black to a hue. The range of a color space is described as its gamut. The color gamut may vary depending upon the specific characteristics of the printing substance, such as the % density of the respective color such that higher densities correspond to more expansive color gamuts and hence larger color ranges.

The ICC profile used to characterise the printer 110 may specify a relationship between a device dependent color space such as an RGB or CMY color space and a Profile Connection Space (PCS), which is a device independent color space. One example of a PCS is a CIELAB color space, which expresses color as three values: L* for luminance from black (0) to white (100); and two chroma values a* from green (negative axis) to red (positive axis); and b* from blue (negative axis) to yellow (positive axis). The CIELAB color space is designed to approximate human vision such that the same amount of numerical change in the (L*, a*, b*) values corresponds to approximately the same amount of perceived change by the human eye. To characterise a printer 110, one goal may be to convert color information of a source image from the CIELAB color space to the CMYK color space to determine the function f( ) in the equation:

$$( C , M , Y , K ) = f ( {L}^{*} , {a}^{*} , {b}^{*} ) . \qquad Equation 1$$

Note that CIELAB and CMYK are not linearly related so a non-linear model is used to perform the color conversion. There are no formulas for conversion between RGB or CMYK values and L*a*b* values because both RGB and CMYK are device dependent. Profiling may be performed for a printer using colorimetric printer characterization. The ICC printer profile may comprise a three-dimensional lookup table to determine conversion from and (L*, a*, b*) color space to a linearized C′M′Y′K′ space followed by a set of four one-dimensional lookup tables (1D LUTs) each of which specifies conversion from C′M′Y′K′ to actual amounts of cyan, magenta, yellow and black ink prior to a half-toning process. Each of the 1D LUTs may be denoted a “linearization curve”, the application of which is good for color reproduction. The four 1D LUTs used to linearize the CMYK values to CIELAB space reduce errors in interpolation that occur when the 3D LUT is used to transform from CIELAB to CMYK for a subset of CIELAB colors on a regularly spaced grid. If the 3D LUT is used without the 1D LUTs then for each pixel of the source image to be printed, a color transformation from L*a*b* to CMYK may involve interpolation between discrete values of the 3D LUT, which may introduce errors, particularly for a coarser 3D LUT grid. Furthermore, in inkjet printing, there may be dot gain variation for different print medium types (e.g. different papers or textiles) as a result of different absorbencies of the media. Dot overlapping behaviour may also vary from medium to medium. These variations may be compensated for via the 1D linearization curve of the ICC profile such that the print quality is more consistent.

The process of linearization may involve printing a series of test patches of, for example, 25 patches for each of the four CMYK ink colors with each of the 25 patches for a given ink color having a different ink density. The ink density may be expressed as a percentage and the increments for patches may be, for example, 5% for higher densities and 1% for lower densities. The ink density is sometimes denoted “ink level”. A spectrophotometer may be used to derive (L*, a*, b*) values for the printed series of test patches. A good linearization to a CIELAB color space may result in an approximately linear relationship between measured lightness L* versus ink density for each of C, K and M. Similarly a plot of a measured b* value against % ink density for Y ink may be approximately linear.

Returning to FIG. 1, the calibration data 120 is received by the printer 110 for a selected print medium. The calibration data 120 may be dynamically generated by the printer 110 when processing a print job, alternatively, the calibration may be performed in advance and stored as a library. The library of calibration data may be stored locally on the printer 110 or may be accessed remotely, for example, via a wired or wireless communication network.

As discussed above, various different types of print medium may be printed on by the printer. Where the printer 110 prints onto a transfer paper rather than an end product article such as a textile, the calibration data 120 may relate to a color range achievable the end product, such as a printed textile generated by sublimation of an image from a transfer paper onto which the printer 110 has printed directly. However, the calibration data 120 could alternatively correspond to a color range measured from the transfer paper itself if this is considered an appropriate measure of print image quality.

The calibration medium in some examples may be selected to match or approximately match the intended print medium for the print job. For example, exactly the same paper, type, weight and finish may be used as the calibration medium and the print medium. However, it may be sufficient to have a calibration medium in broadly the same category as the print medium rather than an exact match.

A first set of color calibration data 120a comprises a first achievable color range (or equivalently color gamut) 121a for printing using a first printing substance load, for example a 10% ink density for each of the four CMYK inks. The achievable color range may be specified in the L*a*b* color space, the L*, a* and b* values having been derived from the test patches printed on a selected printing medium at a first ink loading using a spectrophotometer.

A second set of color calibration data 120b comprises a second achievable color range 121b for printing using a second printing substance load, for example a 20% ink density for each of the four CMYK inks, on the same selected printing medium. The color range 121b achievable with 20% ink density is greater than the color range 121a achievable with the 10% ink density.

A third set of color calibration data 120c comprises a third achievable color range 121c for printing using a third printing substance load, for example a 30% ink density for each of the four CMYK inks, on the same selected printing medium. The color range 121c achievable with 30% ink density is greater than the color range 121b achievable with the 20% ink density.

An Nth set of color calibration data 120N comprises a third achievable color range 121N for printing using a Nth printing substance load, for example a 100% ink density for each of the four CMYK inks, on the same selected printing medium. The color range 121c achievable with 100% ink density is greater than the color range 121b achievable with the 30% ink density or any of the lower intervening densities for which calibration data 120 is available. The total number N of calibration data sets is may vary depending on user specified requests and may also depend on the particular characteristics of the printing substance, selected print medium or the printing device 110.

A printing substance may comprise, for example, a dye-based ink, a pigment-based ink as may be used in an inkjet printer. Alternatively, the printing substance may comprise a stream of finely ground plastics material capable of holding an electrostatic charge as may be used in a color laser printer. Laser toners may comprise separate toner cartridges for different hues similarly to inkjet printer cartridges comprising ink cartridges for different hues. In yet further alternatives the printing substance may comprise a build material for 3D printing.

The printing substance load may provide an indication of an amount of printing substance deposited in a color deposition region by the printer. The amount may be relative, such as a percentage or alternatively may be an absolute amount such as a specific volume or saturation level in a given color space of printing substance. One example measure of a printing substance load is a % ink density level after a linearization process has been performed for the printer 110.

A higher printing substance load may be achieved by: (i) using an ink with a higher concentration of dye or pigment or a laser toner with a higher color concentration; or (ii) by increasing a volume of ink or toner deposited per color deposition region on the print medium. Different print modes may have different number of passes of the printhead over the same swath on the print medium. Thus, a print mode that uses four passes may achieve double the printing substance load relative to a different print mode that uses two passes.

Furthermore, different printing substances may have different chemical and/or physical characteristics such as different viscosities that may influence the printing substance load that can be deposited when a printhead nozzle is fired. Thus, for example, when a nozzle fires cyan ink, less ink may be deposited on a color deposition region than when a nozzle fires yellow ink. Thus, it may be appropriate to use a higher number of passes of cyan than of yellow to achieve the same printing substance load in a given color deposition region.

Prior to loading the source image 130a into the system 100, the printer 110 may access a library of profiles, where a profile for a given printer or a given printing mode of that printer may characterise the implicit printing properties of the printer or of the relevant printing mode. For example, a printer profile may describe how an input signal to the printer generates a color to be printed. For example, an RGB profile corresponding to a PDF file of the flag source image 130a shown in FIG. 1 may specify 100% red, 0% green and 0% blue in a fill region of the flag. Upon receipt of the PDF input file a Raster Image Processor (RIP) in the printer 110 converts the red color of the flag 130a into the CIELAB color space as for example (L*:54; a*:51; b*:70) and then an ICC profile may be used to convert the device independent CIELAB value into a printer-specific CMYK profile to give, for example 2% Cyan, 100% Magenta, 87% yellow and 0% Black to simulate the red of the source image 130 as accurately as possible.

In the printing environment 100 of FIG. 1, the inkjet printer 110 may receive the calibration data 120 and the target range of colors 130 in a device-independent format such as the CIELAB color space and may compare for each of fluid load 1, fluid load 2, fluid load 3 . . . to fluid load N, an achievable range of colors 121a, 121b, . . . , 121N indicated by the calibration data against the target color range 130 of the source image to determine any difference between the target color range 130 and the plurality of potentially achievable color range for the respective printing substance loads 121a, 121b, . . . , 121N. An appropriate printing substance load 140 may thus be identified for a printing job based on at least the comparison. Thus, according to the present technique an algorithmic evaluation of an appropriate printing substance load may be performed to determine an efficient printing substance load that allows faithful reproduction of at least the majority of colors in the source image and yet avoids expenditure of printing substance that does not give rise to significant improvements in image quality in terms of the faithfulness of the color reproduction.

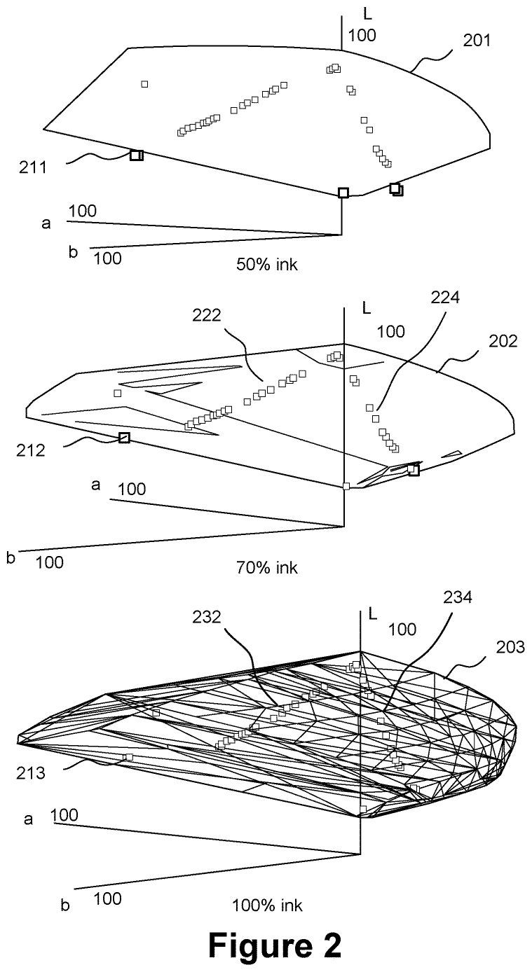

FIG. 2 illustrates a range of colors, or color gamut, 201, 202, 203 achieved on a printing surface (e.g. during a calibration) by each of the plurality of different printing substance loads (e.g. 50%, 70% and 100% respectively). The color gamuts achieved by each of the plurality of different printing substance loads may be defined with respect to any color space. For example, the color gamuts, and each of the colors comprising the color gamut, may be defined with respect to a color space wherein each of the colors of the color gamut are defined by a color vector, and where the color vectors are predetermined according to a standardized scheme. The standardized scheme may be independent of the color generation characteristics of printing and/or displaying devices

FIG. 2 illustrates the range of colors achieved by the plurality of different printing substance loads where the colors are defined with respect to a 3-dimensional color space. The color space used for defining the colors of the color gamut may be the scheme illustrated in the example shown in FIG. 2, i.e. the CIELAB color space as defined by the International Commission on Illumination (CIE). The CIELAB color space, as depicted in FIG. 2, defines a color as a vector with respect to L, a, and b axes, where: the L axes defines lightness with black=0 and white=100; the a axis defines a measure of red vs green contributions for a given color with positive numbers indicating a larger contribution from the red end of the color spectrum and negative numbers indicating a larger contribution from the green end of the color spectrum; and the b axis defines a measure of blue vs yellow contributions for a given color, with negative number indicating a larger contribution from the blue end of the color spectrum and positive numbers indicating a larger contribution from the yellow end of the color spectrum.

The color gamut achieved by each of the respective different printing substance loads may increase with the increase in the total amount of printing substance deposited by the printing substance load. For example, a printing substance load that deposits a smaller total amount of printing substance on the printing surface (e.g. a 50% printing substance load, where a load that deposits a smaller amount of total printing substance is described herein as a smaller, lower or lighter load) may achieve a smaller range, or gamut 201, of colors that are reproduced on the printing surface. A smaller range, or gamut, of color may comprise a smaller number of discrete colors than a larger range or gamut. For example, a printing substance load that deposits a larger total amount of printing substance on the printing surface (e.g. a 70% printing substance load, where a load that deposits a larger amount of total printing substance is described herein as a larger, higher or heavier load) may achieve a larger range, or gamut 202, of colors that are reproduced on the printing surface. The larger range, or gamut, of colors may overlap the smaller range or gamut. For example, the larger range, or gamut, may entirely overlap the smaller range, or gamut, and may comprise all of the colors of the smaller range, or gamut. Alternatively, the larger range, or gamut, may partially overlap the smaller range, or gamut, and may comprise a subset of the colors of the smaller range, or gamut, but may additionally comprise colors not included in the smaller range, or gamut.

FIG. 2 schematically illustrates an example, where each of three different example printing substance loads (e.g. 50%, 70%, 100%) encompass progressively more discrete color space vectors for a target color range corresponding to a given source image. FIG. 2 illustrates gamuts in the CIELAB (L*,a*,B*) device independent color space. A color gamut may be a portion of a color space that a device such as a printer can reproduce. The larger or wider the gamut, the more rich saturated colors that are reproducible. As color gamuts reduce in size, the rich saturated colors tend to be the first colors to be lost, a phenomenon known as clipping. Clipping often happens when converting from RGB to CMYK. In FIG. 2 a first color gamut 201 corresponds to a 50% printing substance load, a second color gamut 202 corresponds to a 70% printing substance load an a third color gamut 203 corresponds to a 100% printing substance load. As the printing substance load increases the corresponding gamut encompasses a progressively larger volume. Also plotted in each of the three (L*,a*, B*) color spaces illustrated in FIG. 2 are a plurality of discrete color points corresponding to a target color range of a source image. The same set of target color points are plotted alongside each of the three color gamuts 201, 202, 203. The set of target color points for a given RGB source image may be converted to the CIELAB color space using the associated ICC profile. The ICC profile may be built-in to the image data.

It can be seen that the target color range has at least three outlier points 211 extending outside the first color gamut 201, whilst others of the target color points are encompassed within the first color gamut 201. The same three outlier points 212 lie closer to the border of the second color gamut 202 with a single one of the three outliers appearing to remain outside an extreme boundary of the color gamut 202. Two distinct lines of target color points 222,224 can be seen within the second color gamut. By way of contrast, the full set of target color vectors including the three previous outliers 213 are encompassed within the boundaries of the third color gamut 203 although a corresponding pair of lines of points 232, 234 can also be seen to be contained within this third gamut 203, which is the largest gamut of the three illustrated.

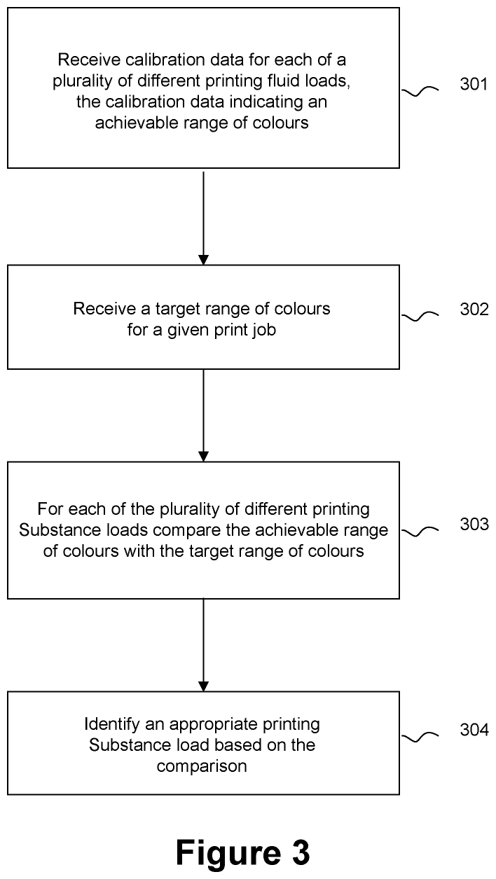

FIG. 3 is a flowchart schematically illustrating an example implementation for algorithmically identifying a printing substance load for printing a job based on a comparison of a target color range for a source image with a series of achievable color ranges from calibration data for respective printing substance loads.

At block 301, the printer 110 of FIG. 1 may receive 301 calibration data for each of the plurality of different printing substance loads, where the calibration data indicates an achievable range of colors, or gamut, for each of the different printing substance loads. The calibration data may be at least one of printer-specific, print medium specific and printing substance type specific. At block 301, the calibration data may be analysed in the L*a*b* color space by taking color readings from, for example, a calibration color chart printout created using CMYK printing substance and analysed using a spectrophotometer to obtain the (L*,a*,b*) readings from which to construct a color gamut.

At block 302 the printer may receive a target range of colors for a print job to be printed. The print job may comprise a computer graphics file such as a pdf file in an RGB color space and the data from this file me converted into a device independent color space such as the CIELAB (L*, a*, b*) color space.

At block 303 processing circuitry in the printer 110 may compare the received achievable range of colors determined at the calibration block 301 with the received target range of colors determined at block 302.

The comparison at block 303 may comprise determining any difference between the target range and the achievable range for each respective load of printing substance. For example, an assessment may be made of how close a match each of the achievable color ranges for the respective different printing substance loads is for the target color range. A meaningful comparison can be performed in the device-independent CIELAB color space. An exact match may not be specified, but a match to within a predetermined tolerance level may be acceptable.

At block 304, an appropriate printing substance load to process the print job corresponding to the target data is identified based on the comparison performed at block 303. It may be that the appropriate printing substance load for printing the print job is identified to minimise (or at least reduce) the total amount of ink that is used to process the print job whilst achieving at least a minimum level of color reproduction quality.

Selection of such a minimal or reduced printing substance load may provide a reduced cost per copy and a higher printing speed. Selection of the appropriate printing substance load may be performed by visually presenting to a user an overlap pf the range of target colors with the achievable gamut for the respective load. The user may view this visual representation on a screen on a control panel of the printer, for example.

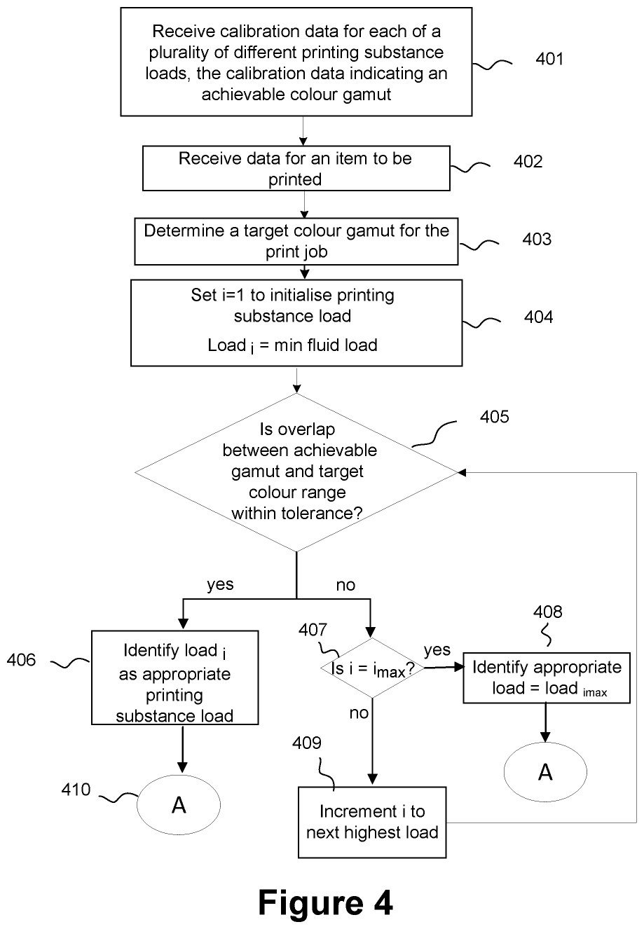

FIG. 4 is a flowchart schematically illustrating identifying a printing substance load for a print job based on a comparison involving an overlap between a discrete numbers of colors in the target color range of the source image and each of the achievable color gamuts for the available range of printing substance loads.

According to the example implementation illustrated in FIG. 4, the printer may receive at block 401 calibration data for each of the plurality of different printing fluid loads, and may receive at block 402 image data for a job to be printed. Then at block 403, a target color range for the print job in a device independent color space may be determined. This target color range may be generated from RGB data corresponding to a source image and an ICC profile connecting the device dependent RGB color space to the device independent Profile Connection Space, which in this example is he CIELAB space.

The determination of any difference between an achievable color range and the target color range or the determination of whether an achievable color range meets the target color range may comprise determining 405, for each of the plurality of different printing substance loads, that the determined discrete number of colors in the achievable color gamut encompasses the color range spanned by the target color range to at least within a given tolerance margin. In some examples the tolerance margin may be set such that any difference of one DE2000 color difference or greater is outside the tolerance margin. This is because a color difference of any color that is one DE2000 color difference or greater is visible to the human eye. In alternative examples the tolerance margin may be differently set.

According to the example implementation illustrated in FIG. 4, an initial printing substance load (loadᵢ) for analysis is identified at block 404. This initial printing substance load may be the minimum, lowest, printing substance load of the plurality of printing substance loads (i, . . . , N), as shown in 404. In alternative example implementations the algorithm may initialise to the maximum available printing substance load and increment down until a discrepancy between the target color gamut and the achievable color gamut is too high or otherwise cycle though a range of different printing substance loads to determine a degree of overlap between the target color range and the achievable color gamut for the respective printing substance load. The degree of overlap may be determined in any one of a number of ways. A discrete number of colors of the color gamut specific to a give printing substance load may be determined for comparison with a target number of discrete colors constituting the source image to perform an assessment of a degree of overlap. Otherwise the span of the color gamut of the given printing substance load may be compared to establish whether or not it fully or partially encompasses the target color range of the source image.

Once the initial printing substance load (loadᵢ) has been selected at block 404, the process proceeds to decision block 405 where the target color gamut data is discretised into a finite number of vectors in the (L*,a*,b*) color space, with each vector representing a distinct color corresponding the source image. For example if the source image is an image of a flag then the colors in the flag may be limited to, for example, red, yellow and blue horizontal bands with a crescent of white starts the corresponding vectors in (L*,a*,b*) color space may be small, for example less than fifty discrete points. However, since each of the achievable color gamuts of the calibration data received at block 401 corresponds to a range of color test patches to determine a full range of colors achievable with the respective printing substance load, the number of discrete colors in the gamut volume may be comparatively large in each case. Table 1 below gives an example of a number of gamut volume colors for each of 50% ink density, 70% ink density and 100% ink density and a relative color gain as density is increased from the 50% value. The ink level in table 1 may be understood as an ink limit per ink channel such as a number of dots per pixel, which may give a measure of an average coverage of ink on the working surface.

TABLE 1

| Ink level (printing | Gamut Volume | Relative color |
|---|---|---|
| substance load) | (number of colors) | gain |
| Printed with 50% ink | 332,594 | 100% |
| Printed with 70% ink | 352,557 | 106% |
| Printed with 100% ink | 395,772 | 119% |

It can be appreciated from Table 1 that with 100% printing substance load 19% more colors of CIELAB color gamut are achievable relative to that achievable with 50% printing substance load and with 76% fluid load 6% more colors are achievable relative to 50% printing substance load. There will be a saturation level of printing substance density at which higher volume of ink or toner or higher density of pigment/dye will provide no further colors (will expand gamut no further). This may correspond to the 100% printing substance load. As illustrated in FIG. 2, for a 50% printing substance load, some target image color vectors are outliers of the achievable color gamut, for 100% printing substance load, all of the target color range vectors including the vectors 213 at the extremities of the boundary are covered by the color gamut 203. The 70% printing substance load provides coverage for the majority of the target color range vectors with merely a small discrepancy between the outlying point 212 and the boundary of the achievable color gamut 202. The CIELAB color space has an associated DE2000 formula that takes into account different sensitivities of the human eye to different colors. For example, the human eye does not discriminate so easily color differences in very saturated colors relative to color differences in pastel colors and near-neutral grey, for which much smaller differences are perceptible to the human eye. A DE2000=1 is a color difference that leads to a difference in perception of the human eye regardless of what color is viewed. Thus, if a discrepancy between the outlying point 212 in FIG. 2 is less than 1 DE2000 color difference then it is not perceptible to the human eye. Thus a color difference of less than DE2000 is one example of a tolerance threshold within which the target color range and the achievable color range may be sought to match in selection of an appropriate printing substance load.

Table 2 below provides an indication of the percentage of colors inside the gamut for each of the 50%, 70% and 100% printing substance loads illustrated in FIG. 2.

TABLE 2

| Ink level (printing | % of Image colors | Colors outside |
|---|---|---|
| substance load) | inside gamut | the gamut |
| Printed with 50% ink | 35% of all image colors | Dark blue, black, |
| | | red |
| Printed with 70% ink | 100% within tolerance | — |
| Printed with 100% ink | 100% | — |

It can be seen from Table 2 above that for the 50% printing substance load, the majority of the colors of the target color range lie outside the achievable gamut. The colors that cannot be reproduced in print with the 50% printing substance load are dark blue, black and red in this example. Although for a 70% printing substance load, some of the target image colors are outside the corresponding color gamut, the differences correspond to color differences that are not perceptible by the human eye. Thus there is nothing to be gained by printing the source image at 100% printing substance load because no difference in image quality will be perceived by the human eye between 70% printing substance load and 70% printing substance load. Selection of a 70% printing substance load should reduce the amount of printing substance used for the print job and may also increase throughput relative to a 100% printing substance load.

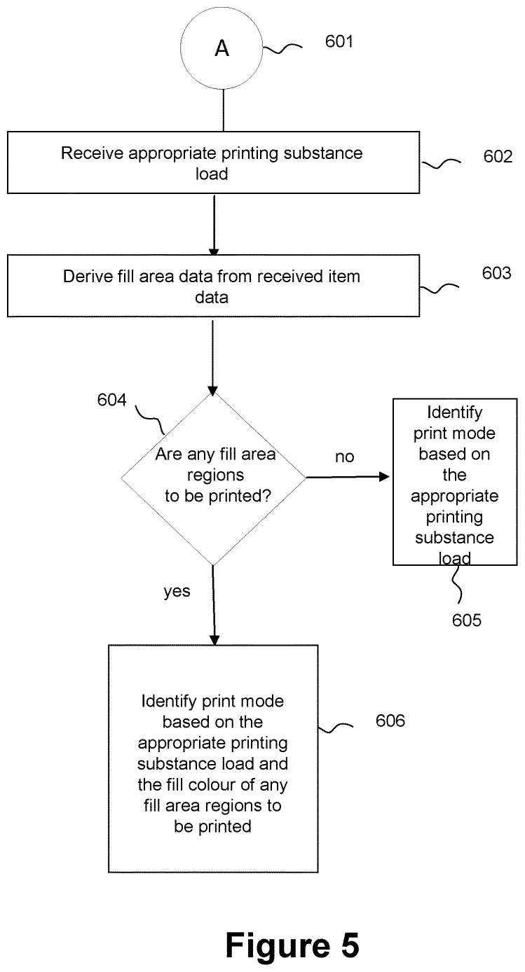

At block 405 it may be determined whether or not the color space spanned by the achievable color gamut for load; incorporates all of the discrete number of colors in the target color range. If there is sufficient overlap between the achievable color gamut and the discrete number of colors in the target color range, then then the process flows to block 406 where the minimum printing substance load (loadᵢ) be identified 406 to be the appropriate printing substance load for the print job and then the method may optionally continue to block “A”, 410, where a print mode may be identified for the print job, based at least on the identified appropriate printing substance load. These additional blocks following “A” are described in more detail in the discussion of FIG. 5 below.

Alternatively, if the discrete number of colors in the achievable color gamut for load; is determined at block 405 not to encompass the discrete number of colors in the target color gamut, the process proceeds to block 407, where provided that the maximum printing substance load has not been reached, the load is further incremented at block 409 and the process returns to block 405 where reproducibility of the full set of target colors is sought at block 405 for the higher printer fluid loading. The loadᵢ may be progressively incremented until coverage o the range of target colors is achieved to at least within a tolerance margin.

Once the maximum printing substance load (load_{N}) of the plurality of printing substance loads is reached at block 407, even if the discrete number of colors in the achievable color gamut for load_{N} is determined not to encompass the discrete number of colors in the target color gamut, 405, load_{N} may be identified, 408, as the appropriate printing substance load in spite at least some target colors being clipped for the available range, and optionally, the method may continue to block A as described above.

Although the method of the example implementation illustrated in FIG. 4 describes an iterative process starting from the lowest printing substance load and incrementing at each iteration to the next highest printing substance load, the method is not so limited, and may utilise any sampling procedure known in the art for identifying the appropriate printing substance load from among the plurality of printing substance loads.

In addition to the identifying an appropriate printing substance load for the print job, any of the preceding example implementations may further comprise determining a print mode for the print job based on at least the printing substance load. A printer may be operable in a plurality of different print modes, where each respective print mode may be characterised by at least a given printing substance load and print speed such that the combination of printing substance loads and print speeds of a given print mode may result in a respective print image quality e.g. resolution and/or color saturation, the saturation being specified in a given color space. The print speed of the printer may depend on at least one of the number of passes to be performed by the printhead of the printer per swath of the print job and the firing frequency of the nozzles of the printhead.

In order to achieve a given quality of printing, the printer 110 may print a larger printing substance load with a lower speed than a smaller printing substance load. For example, in order to deposit a larger printing substance load (e.g. a larger amount of printing substance deposited on a given color deposition region) the printing nozzles of a printer may have to fire with a higher printing frequency, which may increase the stress on the nozzles. In order to reduce stress on the nozzles, or e.g. in order to maintain an image quality parameter such as resolution, the firing frequency of nozzles may be limited to an upper limit. In this case, if a relatively large printing substance load has been identified due to e.g. the desire for a high color saturation (in a given color space), the printer nozzles may reach the upper firing frequency and may use additional passes of the printer head per swath in order to achieve deposition of the larger printing substance load. The addition of passes of the printhead may result in a slower print speed for the print job. The print mode of the printer may be selected based on at least the identified appropriate printing substance load alone. Additionally, the print mode may be selected by further considering the image quality criteria of the print job or by attempting to reduce stress on the printer nozzles.

FIG. 5 illustrates a flowchart according to an example implementation for identifying a printing substance load for printing a job based on a comparison of the achievable color range, or gamut, and a target color range, or gamut, for each of a respective plurality of different printing substance loads and fill area data for the print job. According to the example implementation illustrated in FIG. 5, the printer 110 may receive at block 502 an appropriate printing substance load as determined, for example, by the example implementations illustrated in FIGS. 4, and indicated by reference symbol A, 6501. The printer may also derive at block 503, or otherwise receive, fill area data from received image data corresponding to the print job.

The fill area data may indicate that an area of solid color, or dense pattern, is to be printed, in contrast to areas of text or light patterning. For example, when areas of text or light patterning are to be printed, any defects in the color coverage of the deposited printing substance may not be apparent in the image quality as perceived by a user. In contrast, when a solid fill area or area of dense pattern is printed, any defects in the color coverage of the deposited printing substance may be more apparent to a user. Therefore, in order to maintain a given image quality, or perceived image quality, the color saturation values in a given color space may be higher for the printing of fill areas with respect to the saturation values in the given color space for the printing of, for example text or sparse patterns. The fill area data derived at block 503 may be obtained in some example implementations by using machine learning, deep earning or other artificial intelligence algorithm(s) to analyse the source image. In other examples, the user may enter the fill-area data such as whether or not there are any fill areas to be reproduced and what color any filled areas will be.

According to the example implementation illustrated in FIG. 5, if the fill area data indicates at block 504 that no fill area is to be printed, or that a fill area to be printed is below a predetermined threshold e.g. the fill area is determined to be below a given percentage of the area of the entire printing surface (such as a few or 5 percent), then the printing substance load of the print job is determined at block 505 based on the comparison of the achievable color range and the target color range for each of the plurality of different printing substance loads. For example, as no fill area, or merely a nominal fill area is to be printed, the color saturation (in the given color space) of the print mode appropriate for the print job may not need a relatively large printing substance load to be deposited, as the image quality criteria for the non-solid fill areas may be not be as strict than for fill areas. In the case of block 505, where it is determined that there is no fill area to be printed, there are no additional image quality criteria to be met and the printing substance load can be identified based on a minimum/smallest printing substance load for which the difference or overlap between the achievable color range for the printing substance load and the target color range are within a predetermined threshold.

Additionally, the print mode of the print job may also be determined at block 505 based on the identified printing substance load. For example, the number of passes to be performed by the printhead per swath of the print job in the case of an inkjet printer may be based on the printing substance load as there may not be any additional image quality criteria imposed on the print job because there is not a fill area to be printed. For example, for the given printing substance load, a plurality of different print modes, each with different nozzle firing frequencies and number of passes of the printhead per swath, may be selectable. The print mode for the print job may be selected by considering default or selected configurations for the nozzle firing frequency and/or number of printhead passes per swath. For example, a print mode may be identified for the appropriate printing substance load for which the number of passes to be performed by the printhead per swath of the print job may be e.g. 2 passes. In this case, the print speed may be relatively fast.

Alternatively, if the fill area data indicates at block 506 that a fill area is to be printed, or that a fill area to be printed is above a predetermined threshold (e.g. the fill area exceeds 5 percent of the entire area of the printing surface), the appropriate printing substance load may be determined based on both: (i) the comparison of the achievable color range and the target color range for each of the plurality of different printing substance loads; and (ii) the fill area data. For example, in the case of block 506 where a fill area is to be printed, the image quality criteria of the print job may supersede the considerations of reducing the printing substance load to be deposited. Therefore, it may be that the minimum printing substance load identified for which the achievable color range meets the target color range may not provide the color saturation (measured in the given color space) appropriate for the fill area to be printed, in which case a larger printing substance load may be identified for the print job.

The identification of the printing substance load and/or the selection of a print mode for the print job may be based on the color of the fill area to be printed. Due to the nature of the color components which make up the ink or dye of the printing substance load and the interaction(s) between the printing substance and the nozzles of the printhead, in order to achieve a given image quality for the print job, a different printing substance load or number of printhead passes may be used for each of the different colors of the fill area. For example, in order to achieve a given printed image quality, e.g. cyan and black color components for a solid color fill area four passes of the printhead per swath of printed image may be appropriate, in comparison to e.g. magenta and yellow color components for a solid color fill area, which may use two passes of the printhead.

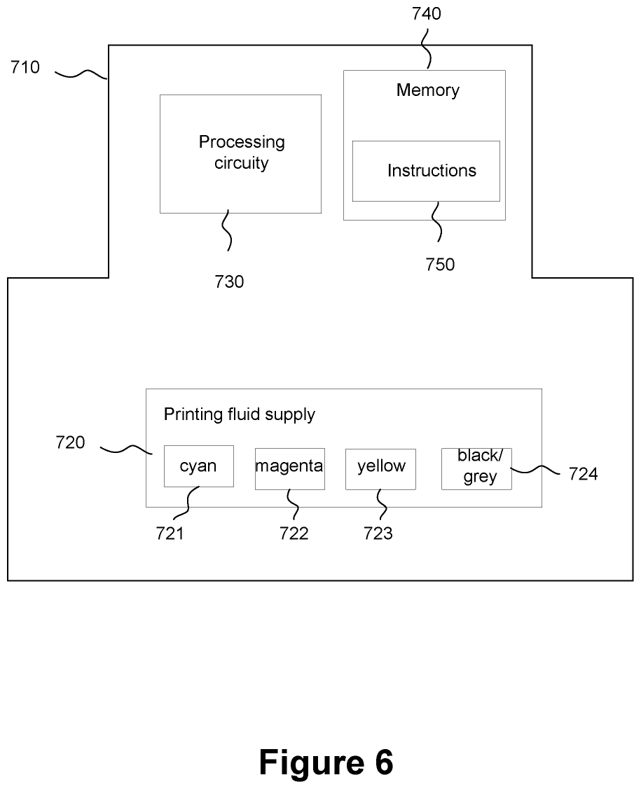

FIG. 6 illustrates a schematic view of a printer 6 comprising a printing substance supply 620, processing circuitry 630 and memory 640 with instructions 650 stored thereon that when executed by the processor of the printer 610 cause the printer to perform any of the example implementations described above. The printing substance supply 620 may comprise color components 621, 622, 623, and 624. The color components may be combined upon deposition on the print medium to form a wide range of different hues, tones and shades. The color components may each carry a respective color pigment or dye to be deposited on the printing surface. For example, the color components may be ink cartridges for each of the respective color components of a CMYK color model. Alternatively, the color components may correspond to the base constituents of other subtractive color models, such as CMY.

The printer may additionally comprise a printhead moveable with respect to the printing surface, the printhead may have a plurality of nozzles mounted thereon. Each of the nozzles, or each of a subset of nozzles, may be fired independently by the processing circuitry 6 of the printer 610. Each of the nozzles, or each of a subset of nozzles, may be connectable to the printing substance supply, and upon firing each nozzle may eject printing substance onto the printing surface.

The printer 6 may additionally comprise receiving circuitry to receive the calibration data and the target color range and may additionally receive additional print job data. For example, the receiving circuitry may operate wirelessly or be wired and may operate using WLAN, LAN or personal are network (PAN) protocols. The receiving circuitry may be configured to wirelessly operate using any current communication standards such as for example IEEE 802.11 WiFi®, IEEE 802.15 Bluetooth® or Near-field Communication (NFC).

Alternatively, the printer 710 may comprise an interface for communicating with external devices. The interface may be implemented as hardware and, for example, may be a bus to operably couple the printer 710 to an external device (e.g. a spectrophotometer).

Although the printer 710 is illustrated as having several separate functional elements, one or more of the functional elements may be combined and may be implemented by combinations of software-configured elements, and/or hardware elements.

Example implementations may be implements in one or a combination of hardware, firmware and software. Example implementations may also be implemented as instructions stored on a computer-readable storage medium, which may be read and executed by at least one processor to perform the operations described herein. A computer-readable storage medium may include any mechanism (e.g. transitory or non-transitory mechanisms) for storing information in a form readable by machine (e.g. a computer). For example, a computer-readable storage device medium include ROM, RAM, magnetic disk storage, optical storage media, flash-memory devices, and other storage devices and media.

Example implementations can be realised according to the following:
Example 1 is a computer program comprising instructions which, when executed by processing circuitry, cause the processing circuitry to:
   receive calibration data, the calibration data indicating an achievable range of colors physically reproducible on a calibration printing surface by a printer for each of a plurality of different printing substance loads, wherein each of the plurality of different printing substance loads provides an indication of a loading of printing substance to be deposited in a color deposition region;
   receive a target range of colors, the target range of colors corresponding to at least a portion of an item for a print job;
   compare for each of the plurality of different printing substance loads the achievable range of reproducible colors and the target range of colors to determine any difference between the target range and the achievable range for each respective printing substance load; and
   identify an appropriate printing substance load for the printer based on at least the comparison.
Example 2 is computer program of example 1, wherein the appropriate printing substance load is a load of printing substance for which the associated achievable range of colors is determined to match, within a given tolerance, the target range of colors based on the respective comparison.
Example 3 is the computer program of example 1 or example 2, wherein the comparison between the achievable range of colors and the target range of colors for each printing substance load comprises determining an overlap between a color gamut corresponding to the achievable range of colors and a color gamut corresponding to the target range of colors.
Example 4 is computer program of example 3, wherein the overlap between the achievable color gamut and the target color gamut for each of the plurality of print loads is determined by performing the comparison in a device independent color space.
Example 5 is computer program of example 3 or example 4, wherein identifying the appropriate printing substance load comprises determining if overlap between a color gamut corresponding to the achievable range of colors and a color gamut corresponding to the target range of colors result in reproduction of the target range of colors to within a predetermined tolerance level.
Example 6 is computer program of any one of examples 1 to 5, wherein each of the plurality of printing substance loads corresponds to a respective printing substance density or volume.
Example 7 is computer program of one of examples 1 to 6, wherein a print mode for the job is determined based on the appropriate printing substance load identified for printing.
Example 8 is the computer program of one of examples 1 to 7, wherein the identification of the printing substance load for printing further comprises:
   receiving fill area data of the item to be printed;
   determining that a fill area of the item to be printed exceeds a fill threshold; and
   identifying the appropriate printing substance load for printing the print job further based on a color of the fill area of the item to be printed.
Example 9 is a computer-implemented method comprising:
   receiving calibration data, the calibration data indicating an achievable range of colors physically reproducible on a calibration printing surface by a printer for each of a plurality of different printing substance loads, wherein each of the plurality of different printing substance loads provides an indication of a loading of printing substance to be deposited in a color deposition region;
   receiving a target range of colors, the target range of colors corresponding to at least a portion of an item to be printed;
   comparing for each of the plurality of different printing substance loads the achievable range of reproducible colors and the target range of colors to determine any difference between the target range and the achievable range for each respective printing substance load; and
   identifying an appropriate printing substance load for reproduction of the at least a based on at least the comparison.
Example 10 is a printer comprising:
a printing substance supply; and
   processing circuitry to execute the method of example 1.
Example 11 is printer of example 10, further comprising a spectrophotometer, wherein the calibration data is captured by the spectrophotometer.
Example 12 is he printer of example 10 or example 11, wherein each of the plurality of printing substance loads prints the job with a respective color saturation level in a given color space.
Example 13 is the printer of any one of examples 10 to 12, wherein the comparison between the achievable range of colors and the target range of colors for each printing substance load comprises determining at least a minimum overlap between a color gamut corresponding to the achievable range of colors and a color gamut corresponding to the target range of colors.

1. A computer program comprising instructions which, when executed by processing circuitry, cause the processing circuitry to:
receive calibration data, the calibration data indicating an achievable range of colors physically reproducible on a calibration printing surface by a printer for each of a plurality of different printing substance loads, wherein each of the plurality of different printing substance loads provides an indication of a loading of printing substance to be deposited in a color deposition region;
receive a target range of colors, the target range of colors corresponding to at least a portion of an item for a print job;
compare for each of the plurality of different printing substance loads the achievable range of reproducible colors and the target range of colors to determine any difference between the target range and the achievable range for each respective printing substance load; and
identify an appropriate printing substance load for the printer based on at least the comparison.

2. The computer program of claim 1, wherein the appropriate printing substance load is a load of printing substance for which the associated achievable range of colors is determined to match, within a given tolerance, the target range of colors based on the respective comparison.

3. The computer program of claim 1, wherein the comparison between the achievable range of colors and the target range of colors for each printing substance load comprises determining an overlap between a color gamut corresponding to the achievable range of colors and a color gamut corresponding to the target range of colors.

4. The computer program of claim 3, wherein the overlap between the achievable color gamut and the target color gamut for each of the plurality of print loads is determined by performing the comparison in a device independent color space.

5. The computer program of claim 3, wherein identifying the appropriate printing substance load comprises determining if overlap between a color gamut corresponding to the achievable range of colors and a color gamut corresponding to the target range of colors result in reproduction of the target range of colors to within a predetermined tolerance level.

6. The computer program of claim 1, wherein each of the plurality of printing substance loads corresponds to a respective printing substance density or volume.

7. The computer program of claim 1, wherein a print mode for the job is determined based on the appropriate printing substance load identified for printing.

8. The computer program of claim 1, wherein the identification of the printing substance load for printing further comprises:
receiving fill area data of the item to be printed;
determining that a fill area of the item to be printed exceeds a fill threshold; and
identifying the appropriate printing substance load for printing the print job further based on a color of the fill area of the item to be printed.

9. A computer-implemented method comprising:
receiving calibration data, the calibration data indicating an achievable range of colors physically reproducible on a calibration printing surface by a printer for each of a plurality of different printing substance loads, wherein each of the plurality of different printing substance loads provides an indication of a loading of printing substance to be deposited in a color deposition region;
receiving a target range of colors, the target range of colors corresponding to at least a portion of an item to be printed;
comparing for each of the plurality of different printing substance loads the achievable range of reproducible colors and the target range of colors to determine any difference between the target range and the achievable range for each respective printing substance load; and
identifying an appropriate printing substance load for reproduction of the at least a based on at least the comparison.

10. A printer comprising:
a printing substance supply; and
processing circuitry to execute the method of claim 1.

11. The printer of claim 10, further comprising a spectrophotometer, wherein the calibration data is captured by the spectrophotometer.

12. The printer of claim 10, wherein each of the plurality of printing substance loads prints the job with a respective color saturation level in a given color space.

13. The printer of claim 10, wherein the comparison between the achievable range of colors and the target range of colors for each printing substance load comprises determining at least a minimum overlap between a color gamut corresponding to the achievable range of colors and a color gamut corresponding to the target range of colors.
